(19) United States
(12) Patent Application Publication
(10) Pub. No.: US 2007/0026127 A1
(43) Pub. Date: Feb. 1, 2007

(54) Packaged food product

(75) Inventor: Hubertus Cornelis van Gastel, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/494,133

(22) Filed: Jul. 27, 2006

(30) Foreign Application Priority Data
Jul. 28, 2005 (EP) EP05076737.5
Jul. 28, 2005 (EP) EP05076738.3

(51) Int. Cl. A23D 7/00

(52) U.S. Cl. 426/602

(57) ABSTRACT

A packaged food product with an extended shelf life.

The present invention relates to the field of food products and in particular to the field of packaged food products.

Consumers increasingly seek the convenience of packaged food products such as ready to use salad dressings, sauces, soups and other meal components. Food products like salad dressings may comprise of an aqueous phase, an oil phase and pieces of vegetable, nut, cheese or any other type of food. To ensure that packaged food products are successful a number of requirements need to be met. Ideally, packaged food products need to be storage stable as it usually takes some time for packaged food products to reach the end consumer. After production, packaged food products are usually stored at various points in the supply chain before the food product is actually consumed.

Indeed, the prior art salad dressings prepared industrially that do have relatively long shelf life have been limited to rather frugal compositions comprising merely oil, vinegar, emulsifier and often no salad toppings like chunks of pepper, mushrooms, cheese, nuts etc. If herbs are used, typically 1-5 wt % is used, partly for cosmetic reasons.

In contrast, a typical home-made salad dressing may be prepared by mixing vinegar and olive oil with chunks of pepper, pine seeds and perhaps cheese in a bowl. However, such a food product has a relatively short shelf life of perhaps only one day as the food particles quickly deteriorate in taste and appearance.

Therefore, there is a need to provide a packaged food product with high amounts of vegetables and other foods with an extended shelf life at 20° C.

Surprisingly we have now found it is possible to provide a food product with an extended shelf life and minimal taste migration.

### SUMMARY OF THE INVENTION

The present invention provides a packaged food product with an extended shelf life whereby the packaged food product comprises a salad dressing in a container whereby
a) the salad dressing comprises a liquid part and a solid part whereby the liquid part comprises an oil phase and an aqueous phase and the solid part comprises food particles and upon standing the liquid part separates into a top layer comprising the oil phase and a base layer comprising the aqueous phase, and
b) the container comprises sides, a bottom face and top face defining at least one single continuous cavity whereby said cavity is divided in a top portion to hold said oil phase and a base portion to hold said aqueous phase and the container further comprises a suspender connected to the sides, top and/or bottom of the container to keep at least part of the food particles suspended in the oil phase and the suspender comprises at least one opening which is large enough to allow the aqueous phase to be poured out of container.

According another aspect of the invention a packaged food product is provided with an extended shelf life at 20° C. whereby said salad dressing comprises a liquid part and a solid part, whereby the liquid part comprises an oil phase and an aqueous phase and the solid part comprises food particles and upon standing the liquid part separates into a top layer comprising the oil phase and a base layer
whereby the salad dressing comprises
a) less than 25 wt %, preferably less than 20 wt %, more preferably less than 10 wt %, and at least 0.1 wt %, preferably at least 1 wt %, more preferably at least 2 wt % of an aqueous phase;
b) at least 15 wt %, preferably at least 20 wt %, more preferably at least 25 wt % and less than 65 wt %, preferably less than 55 wt %, more preferably less than 10 wt % of an oil phase, and
c) at least 30 wt %, preferably at least 35 wt %, more preferably at least 40 wt % and less than 85 wt %, preferably less than 75 wt %, more preferably less than 65 wt % of food particles, by weight of the total salad dressing;
whereby amounts of aqueous phase, oil phase and food particles are such that at least 10 wt %, preferably at least 30 wt %, more preferably at least 50 wt %, most preferably at least of 70 wt % the food particles by weight of the total amount of the solid part is immersed in the oil phase during the storage and the from 0 to 0.1 wt % of emulsifier.

### DETAILED DESCRIPTION OF THE INVENTION

The present invention relates to a packaged salad dressing with an extended shelf life which may be sold in supermarkets or other points of sale. The packaged food product is preferably a salad dressing provided it comprises of a liquid part and a solid part whereby the liquid part comprises of an aqueous phase and an oil phase. The food product is packaged in a container, preferably such that the food product is sealed in an airtight manner. The container may be a tub with a removable lid or a standing flexible pouch also known as a doy pack.

The container comprises sides, a bottom face and top face defining at least one single continuous cavity whereby said cavity is divided in a top portion to hold said oil phase and a base portion to hold said aqueous phase and the container further comprises a suspender connected to the sides, top and/or bottom of the container to keep at least part of the food particles suspended in the oil phase and the suspender comprises at least one opening which is large enough to allow the aqueous phase to be poured out of container.

Since the liquid part of the salad dressing is able to separate into an oil phase and an aqueous phase upon standing, it will be clear to the skilled person that the salad dressing is pourable, i.e. the liquid part has such a low viscosity that the salad dressing can be easily poured out of the container when this is opened. An additional advantage of the inventive packaged salad dressing is that it enables the consumer to shake the container just before opening the container to mix the aqueous and oil phase. The salad dressing preferably contains no or only a small amount of emulsifier and the mixed phases will separate very quickly. Thus, when poured out of the container after shaking the container the oil and aqueous phase of the salad dressing are usually transiently mixed. Yet another advantage of the inventive packaged salad dressing is that although during transport the container comprising the salad dressing may be agitated whereby the liquid phases are mixed transiently, upon standing during storage the liquid phases will quickly separate and at least part of the food particles will be suspended in the oil phase during storage.

Pourable for the present purpose preferably means that the most viscous phase of the liquid part of the salad dressing has a Brookfield viscosity of from 1 to 15000 cps, more preferably from 1 to 6000 cps. If the aqueous phase does not comprise thickeners the most viscous phase will usually be the oil phase. Depending on the oil used and if thickener is used, the amount of thickener used, the aqueous phase may be the most viscous. These viscosities correspond to those of pourable dressings. Brookfield viscosity is a common viscosity parameter and is determined by taking the viscosity after shearing for 1 minute at 10 rpm using a Brookfield DV-I+® viscometer fitted with an RV no. 4 spindle set at 20 degrees Celsius.

When the container is a tub, the top face will usually be a lid which can be removed to open the container for pouring out the food product. When the container is a standing flexible pouch the top face is meant to describe the top part of the pouch where usually the front and back side are sealed together. The top face of the pouch often has a marking to show where the consumer can open the pouch by cutting the pouch open. The opening of the container should obviously be large enough for the food product to exit the container. The container can be re-sealable.

The bottom portion of the container of the packaged food product according to one aspect of the invention holds the bottom layer comprising the aqueous phase (and any unsuspended food particles, if any) and usually comprises less than 25 v/v %, preferably less than 20 v/v %, more preferably less than 10 vv %, and at least 0.1 v/v %, preferably at least 1 v/v %, more preferably at least 2 v/v % of the volume of the container. The remaining part is the top portion which usually holds top layer comprising the oil phase, the suspended food particles in the oil phase and, optionally any headspace.

One of the advantages of the present invention is that the consumer only has to open one single container to use the product. Other products may comprise different sachets for different components, for example one for a powdered seasoning base and one for a seasoning oil. This requires more packaging material and is more cumbersome as the consumer needs to open more than one container. Another advantage is that the present invention enables a simpler form of processing as only one single container needs to be filled with the food product instead of filing separate containers or separate compartments in one container. Once filled with the food product comprising the liquid and solid part, upon standing, the aqueous phase and oil phase will separate due to gravity whereby the food particles will be suspended in the oil phase.

The packaged food product described herein shows surprisingly little taste migration.

Preferably, the liquid part comprises from 0 to 0.1 wt % of emulsifier. If emulsifier is used, it should be in such amounts that phase separation occurs after standing for 10 to 60 minutes, preferably after standing for 1 to 10 minutes, more preferably after standing 1-9 seconds. Phase separation for the present purpose occurs when the oil phase and aqueous phase are clearly visible as two distinct layers, although the interface between the two layers may comprise a minor amount of an emulsion of aqueous and oil phase. Minor amount in this context is meant to describe an amount of emulsion comprising less than 10 wt % of the oil phase by weight of the total amount of oil phase. It is preferred that the liquid part comprises no emulsifier at all.

The container comprises at least on single continuous cavity to hold the food product, i.e., when the container is opened the complete food product can be poured out of the container comprising the food particles, the oil and the aqueous phase. During production one of the advantages of the present invention is that only one container needs to be filled instead of having to fill separate sachets or different compartments in one tray.

The suspender can have any form as long as it allows the aqueous phase to be poured out of the container. For example, the at least one opening should not be so small it hinders the flow of the aqueous phase through the suspender when the food product is poured out of the container.

The suspender may be attached to any part of the container such as the sides, the bottom face or the top face. According to one preferred embodiment the suspender is formed by a grid or a net. In a particular preferred embodiment the grid or net is connected to the sides of the container and located horizontally in the top portion of the container holding the oil phase of the food product. Preferably, the suspender is connected to the sides such that it stays connected when the salad dressing is poured out of the container. The present invention is however not limited to the way the grid or net is connected to the container. For example the grid or net may also be connected to the bottom face through one or more columns. In another embodiment (not shown) the suspender may also be formed by a plurality of columns connected to at least one side and extending from the side towards the middle of the container. The plurality of columns could end in the middle of the container forming a pattern like spokes in a wheel. In the alternative (not shown) the plurality of columns could be connected to two opposite sides of the container whereby the plurality of columns are placed parallel to each other forming a horizontal grid.

According to another preferred embodiment the suspender is formed by a plurality of vertical columns extending from the bottom face of the container whereby the top ends of said columns end in the oil phase layer and the at least one opening between the plurality of vertical columns is large enough to allow the aqueous phase to be poured out of the container but small enough keep the food particles suspended in the oil phase.

The columns may be on any shape, for example tapered towards the top or the bottom end of the column, hollow or solid, thick or thin, as long as the plurality of columns can prevent at least 10 wt % of the food particles by weight of the total amount of the solid part to enter into the aqueous phase reservoir.

According to yet another preferred embodiment the suspender is formed by one or more recesses in the bottom of the container and the at least one opening of the one or more recesses is large enough to allow the aqueous phase to be poured out of the container but small enough to keep at least part of the food particles suspended in the oil phase.

Preferably the at least one opening or openings in the suspender is/are large enough to allow the aqueous phase to be poured out of the container but small enough to prevent at least 10 wt %, preferably at least 30 wt %, more preferably at least 50 wt %, most preferably at least of 70 wt % the food particles by weight of the total amount of the solid part to enter into the base layer comprising the aqueous phase.

Preferably, at least one opening or openings in the suspender is/are large enough to allow the aqueous phase to exit the container when poured in less than 10 seconds, preferably less than 5 seconds and preferably in at least 0.01 second.

It will be clear to a skilled person how large the at least one opening or openings in the suspender should be depending on the viscosity of the liquid part and the size of the particles used to achieve above these preferred times or suspension of particles.

The at least one opening may have any form like rectangle, square, circle, triangle etc and preferably has circumference of at least 1 mm, preferably at least 1 cm, more preferably at least 4 cm.

Preferably the largest circumference of the food particles for at least 10%, preferably at least 30 wt %, more preferably at least 50 wt %, most preferably at least of 70 wt % of the food particles by weight of the total amount of the solid part is at least 1.01 cm, preferably at least 4.01 cm, more preferably at least 8.01 cm.

The packaging may be made of any food grade material according to processes known in the art. In one preferred embodiment, the packaging is light proof. The packaging may be made from any suitable material such as polyester (PET), metal laminate such as aluminium (Ia), polyethylene (PE), polypropylene (PP), polyethylene vinyl alcohol copolymer (EVOH). polystyrene, polyvinyl, polyamide and mixtures thereof.

Packaging may be single or multi layer. Especially preferred are flexible containers such as a doy pack or pouches. Preferred combinations of materials for multi layer packaging include: PET/Ia/PE, PET/Ia/PP, PET/EVOH/PE, PET/EVOH/PP and PET/PP. The suspender may be made using any of the above materials and combinations thereof.

The packaging may be produced according to any suitable method known to the person skilled in the art such as described in WO2004012919, WO2901546, WO2004071745, U.S. Pat. No. 6,806,338, WO-A-93/01108, U.S. Pat. No. 4,769,261, WO2003022708.

The food product may be packaged under oxygen poor or oxygen free atmosphere like nitrogen. In addition, the food product may be pasteurised or sterilised. One of the advantages of the packaged food product according to the invention is an extended shelf life. Extended shelf life for the present purpose is meant to describe a shelf life which is longer than 30 days preferably longer than 60 days, preferably longer than 90 days when stored at 20° C.

Preferably, the total volume of the food product is less than 500 ml, preferably less than 300 ml, more preferably less than 200 ml and at least 20 ml, preferably at least 50 ml, more preferably at least 80 ml.

For those embodiments where the food product is a salad dressing the oil phase may comprise any oil suitable for human consumption. When the oil is an olive oil it may be of any grade such as extra virgin or virgin olive oil. Preferably the oil phase comprises an oil selected from olive oil, soy oil, sunflower oil, peanut oil, walnut oil or mixtures thereof.

The aqueous phase preferably comprises an organic acid in such an amount that the pH of the aqueous phase is more than 2.0, preferably more than 3.0, most preferably more than 3.5 and preferably less than 6.0 more preferably less than 5.0, most preferably less than 4.3. Such an organic acid can suitably be chosen from acetic acid (e.g. from vinegar), citric acid, lactic acid or mixtures thereof.

In a particularly preferred embodiment the food product is a salad dressing with a large amount of food particles, whereby the food product comprises

less than 25 wt %, preferably less than 20 wt %, more preferably less than 10 wt %, and at least 0.1 wt %, preferably at least 1 wt %, more preferably at least 2 wt % of an aqueous phase;

at least 15 wt %, preferably at least 20 wt %, more preferably at least 25 wt % and less than 65 wt %, preferably less than 55 wt %, more preferably less than 50 wt % of an oil phase,

at least 30 wt %, preferably at least 35 wt %, more preferably at least 40 wt % and less than 85 wt %, preferably less than 75 wt %, more preferably less than 65 wt % of food particles, by weight of the total food product.

In a particularly preferred embodiment, the amounts of aqueous phase, oil phase and food particles are such at least 10 wt %, preferably at least 30 wt %, more preferably at least 50 wt %, most preferably at least of 70 wt % the food particles by weight of the total amount of the solid part is immersed in the oil phase during the storage and the from 0 to 0.1 wt % of emulsifier.

The food particles may be derived from any food fit for human consumption and are preferably selected from the group consisting of—either whole or pieces thereof—vegetable, fruit, cheese, nut, seed, meat, fish, flavouring agent and combinations thereof.

Very suitable food particles are selected from the group consisting of—either whole or pieces thereof—pepper, mushroom, tomato, cheese, bacon, pine nuts, sunflower seeds and mixtures thereof.

To impart a specific flavour to the food product herein disclosed it may be preferred that the food product further comprises flavouring agents selected from the group comprising salt, herbs, spices, onions, chopped garlic, garlic oil, or mixtures thereof, in an amount of 0.1-25 wt % based on the total mixture.

### DRAWINGS

To illustrate the invention, the following FIGS. 1 to 4 show non-limiting embodiments which are particularly preferred.

FIG. 1 shows the cross section of a preferred embodiment of the invention whereby the food product is packaged in a tub having sides (1), bottom face (2) and a top face (3) defining a single continuous cavity (4) (lid of the tub is not shown). The food product comprises a liquid part and a solid part whereby the liquid part comprises an oil phase and an aqueous phase and the solid part comprises food particles (5) and upon standing the liquid part separates into a top layer comprising the oil phase (6) and a base layer comprising the aqueous phase (7). The tub comprises a top portion (1A) to hold the oil phase and a base portion (1B) to hold the aqueous phase and the container further comprises a suspender (8) in the form of a grid connected to the sides (1) to keep at least part of the food particles (5) suspended in the oil phase and the suspender comprises at least one opening (9) which is large enough to allow the aqueous phase to be poured out of the container.

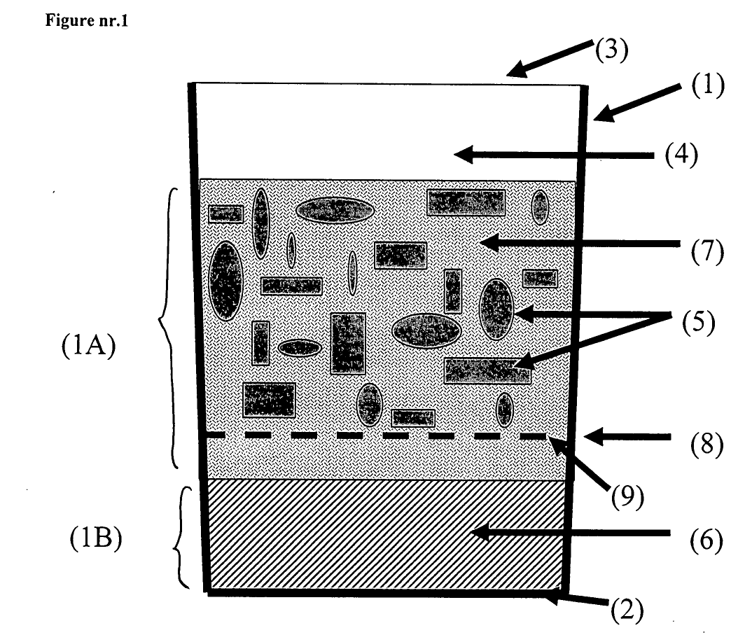

FIG. 2 shows the cross section of another preferred embodiment of the invention. Similar to FIG. 1, the food product is packaged in a tub having sides (21), bottom face (22) and a top face (23) defining a single continuous cavity (24) (lid of the tub is not shown). The food product comprises a liquid part and a solid part whereby the liquid part comprises an oil phase and an aqueous phase and the solid part comprises food particles (25) and upon standing the liquid part separates into a top layer comprising the oil phase (26) and a base layer comprising the aqueous phase (27). The container comprises a top portion (21A) to hold the oil phase and a base portion (21B) to hold the aqueous phase and the container further comprises a suspender (28) is formed by a plurality of vertical columns (29) extending from the bottom face (22) of the container and the top ends of said columns (29) end in the oil phase layer (26) whereby the at least one opening (30) between the plurality of vertical columns is large enough to allow the aqueous phase to be poured out of the container but small enough keep the food particles suspended in the oil phase.

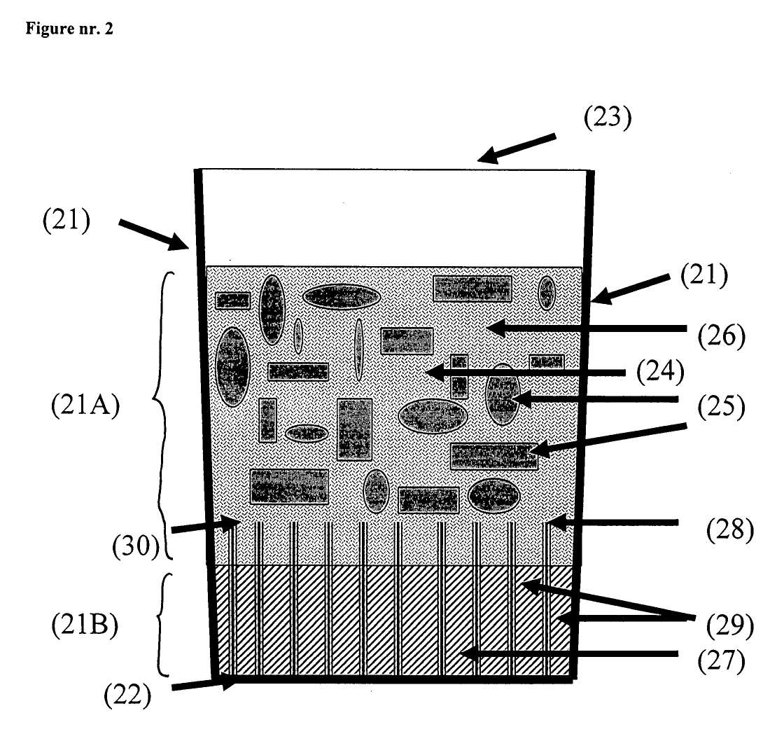

FIG. 3 shows the cross section of yet another preferred embodiment of the invention. The food product is packaged in a standing flexible pouch sometimes called a doypack having sides (31), bottom face (32) and a top face (33) defining a single continuous cavity (34). The food product comprises a liquid part and a solid part whereby the liquid part comprises an oil phase and an aqueous phase and the solid part comprises food particles (35) and upon standing the liquid part separates into a top layer comprising the oil phase (36) and a base layer comprising the aqueous phase (37). The doypack comprises a top portion (31A) to hold the oil phase and a base portion (31B) to hold the aqueous phase and the container further comprises a suspender (38) in the form of a net connected to the sides (31) to keep at least part of the food particles (35) suspended in the oil phase and the suspender (38) comprises at least one opening (39) which is large enough to allow the aqueous phase to be poured out of the container.

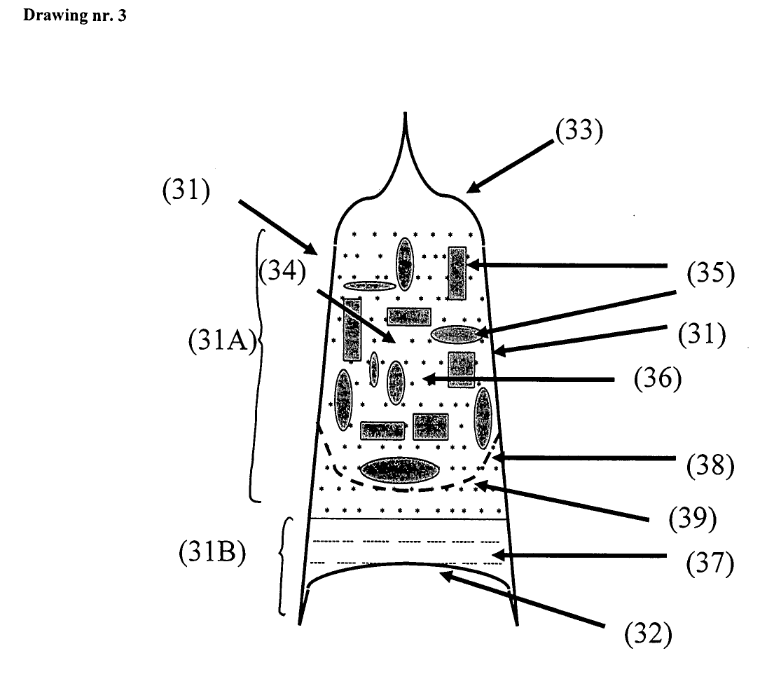

FIG. 4 shows the cross section of another preferred embodiment of the invention. Similar to FIG. 1, the food product is packaged in a tub having sides (41), bottom face (42) and a top face (43) defining a single continuous cavity (44). The food product comprises a liquid part and a solid part whereby the liquid part comprises an oil phase and an aqueous phase and the solid part comprises food particles (45) and upon standing the liquid part separates into a top layer comprising the oil phase (46) and a base layer comprising the aqueous phase (47). The container comprises a top portion (41A) to hold the oil phase and a base portion (41B) to hold the aqueous phase and whereby the suspender (48) is formed by one or more recesses (49) in the bottom face (42) of the container and the at least one opening (50) of the one or more recesses is large enough to allow the aqueous phase to be poured out of the container but small enough to keep at least part of the food particles suspended in the oil phase.

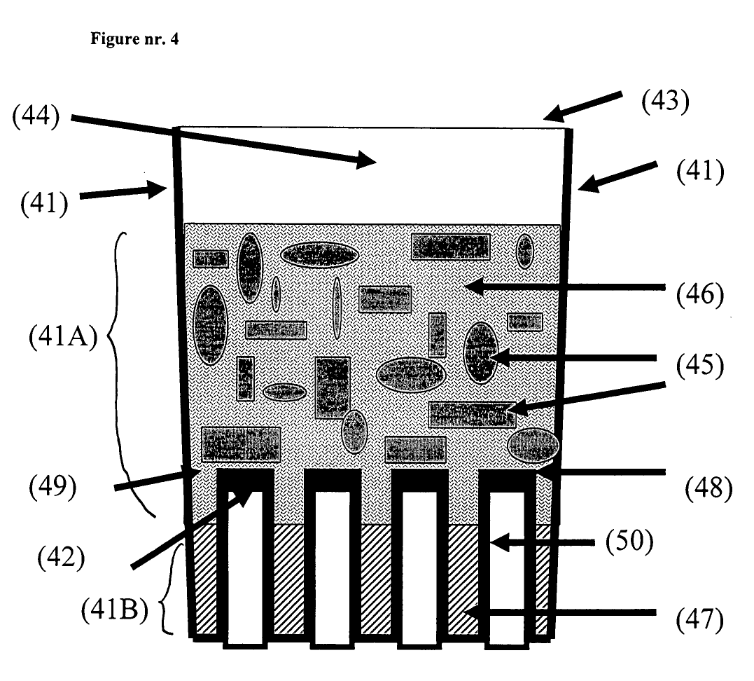

### EXAMPLE 1

A salad dressing according to the invention comprises the ingredients as in the table below.

| Ingredient | Wt % |
|---|---|
| Food particles (peppers, cheese) | 35 to 65 |
| Oil phase (eg olive oil) | 30 to 60 |
| Aqueous phase (vinegar) | 3 to 8 |
| flavouring agents (herbs, salt etc) | 0.1 to 25 |

The amounts of oil, vinegar and food particles are such that at least 10 wt % of the food particles is immersed in the oil phase.

1. A packaged food product comprising a salad dressing in a container whereby
a) the salad dressing comprises a liquid part and a solid part whereby the liquid part comprises an oil phase and an aqueous phase and the solid part comprises food particles and upon standing the liquid part separates into a top layer comprising the oil phase and a base layer comprising the aqueous phase, and
b) the container comprises sides, a bottom face and top face defining at least one single continuous cavity whereby said cavity is divided in a top portion to hold said oil phase and a base portion to hold said aqueous phase and the container further comprises a suspender connected to the sides, top and/or bottom of the container to keep at least part of the food particles suspended in the oil phase and the suspender comprises at least one opening which is large enough to allow the aqueous phase to be poured out of container.

2. A packaged food product according to of claim 1 whereby the suspender is formed by a grid or a net, preferably horizontally connected to the sides of the container.

3. A packaged food product according to claim 1 whereby the suspender is formed by a plurality of vertical columns extending from the bottom face of the container whereby the top ends of said columns end in the oil phase layer and the at least one opening between the plurality of vertical columns is large enough to allow the aqueous phase to be poured out of the container but small enough keep the food particles suspended in the oil phase.

4. A packaged food product according to claim 1 whereby the suspender is formed by one or more recesses in the bottom of the container and the at least one opening of the one or more recesses is large enough to allow the aqueous phase to be poured out of the container but small enough to keep at least part of the food particles suspended in the oil phase.

5. A packaged food product according to claim 1 whereby the at least one opening or openings in the suspender are large enough to allow the aqueous phase to be poured out of the container but small enough to prevent at least 10 wt %, preferably at least 30 wt %, more preferably at least 50 wt %, most preferably at least of 70 wt % the food particles by weight of the total amount of the solid part to enter into the base layer comprising the aqueous phase.

6. A packaged food product according to claim 1 whereby the at least one opening has circumference of at least 1 mm.

7. A packaged food product according to claim 1 whereby the largest circumference of the food particles for at least 10% of the food particles by weight of the total amount of the solid part is at least 1.01 cm.

8. A packaged food product according to claim 1 whereby the salad dressing comprises
a) less than 25 wt % of an aqueous phase;
b) at least 15 wt % of an oil phase, and
c) at least 30 wt % of food particles, by weight of the total salad dressing.

9. A packaged food product according to claim 1 whereby the total volume of the salad dressing is less than 500 ml and at least 20 ml.

10. A packaged food product according to claim 1 whereby the food particles are selected from the group consisting of—either whole or pieces thereof—pepper, mushroom, tomato, cheese, bacon, pine nuts, sunflower seeds, and mixtures thereof.

11. A packaged food product according to claim 1 whereby the aqueous phase comprises an organic acid in such an amount that the pH of the aqueous phase is more than 2.0, and preferably less than 6.0.

12. A packaged food product according to claim 1 whereby the at least one opening in the suspender is such that at least 75 wt % and at the most 100 wt % of the aqueous phase exits said container when the product is poured out of the container.

13. A packaged food product according to claim 1 whereby the aqueous phase exits the container when poured in less than 10 seconds, and in at least 0.01 second.
